(19) United States
(12) Patent Application Publication
(10) Pub. No.: US 2026/0079656 A1
(43) Pub. Date: Mar. 19, 2026

(54) INFORMATION PROCESSING APPARATUS, PRINT SETTING APPLICATION, AND PRINT SYSTEM

(71) Applicant: CANON KABUSHIKI KAISHA, Tokyo (JP)

(72) Inventors: KAZUYUKI SAITO, Kanagawa (JP); YUICHI HASAMA, Chiba (JP)

(21) Appl. No.: 19/396,037

(22) Filed: Nov. 20, 2025

Related U.S. Application Data
(63) Continuation of application No. 18/326,449, filed on May 31, 2023.
Application No. 18/326,449 is a continuation of application No. PCT/JP2021/043243, filed on Nov. 25, 2021.

(30) Foreign Application Priority Data
Dec. 3, 2020 (JP) 2020-201256
Apr. 9, 2021 (JP) 2021-066688

(51) Int. Cl. G06F 3/12

(52) U.S. Cl. CPC G06F 3/1245; G06F 3/1205; G06F 3/126

(57) ABSTRACT

An information processing apparatus described in this specification includes a selection unit configured to select a print queue to be used from among print queues registered in a server system, a control unit configured to display, when a print queue is selected in which print data transmitted by the server system is to be received without intermediation of another server system configured to convert a format of the print data, a print setting screen with which a predetermined setting item is allowed to be set, and to display, when a print queue is selected in which the print data is to be received via the other server system, a print setting screen with which the predetermined setting item is not allowed to be set, and a transmission unit configured to transmit, to the server system, print data based on a print setting which is set via the print setting screen.

### CROSS-REFERENCE TO RELATED APPLICATIONS

This application is a Continuation of U.S. application Ser. No. 18/326,449 filed May 31, 2023, which is a Continuation of International Patent Application No. PCT/JP2021/043243, filed Nov. 25, 2021, which claims the benefit of Japanese Patent Application No. 2020-201256, filed Dec. 3, 2020 and No. 2021-066688, filed Apr. 9, 2021, each of which is hereby incorporated by reference herein in their entirety.

### TECHNICAL FIELD

The present invention relates to an information processing apparatus, a print setting application, and a print system.

### BACKGROUND ART

A system has been proposed in which print data is transmitted to a printer from a client terminal via a cloud server. In the above-mentioned system, a user operates a printer driver installed in the client terminal to perform a print setting to issue a print instruction. The printer driver installed in the client terminal is configured to transmit print data based on image data and the print setting to the cloud server. When the cloud server transmits the received print data to the printer, printing can be performed.

For the printer to receive the print data transmitted from the cloud server and to execute printing, the printer is to have a mechanism for interpreting the received print data. However, among printers in related art, some do not have the mechanism for interpreting the print data transmitted from the cloud server. PLT 1 discloses a cloud print system in which a printer in related art which is not capable of interpreting print data transmitted by a cloud server is used by also using a proxy server capable of interpreting the print data transmitted by the cloud server. According to PLT 1, the proxy server receives print data from the cloud server to convert the print data into a format that can be interpreted by the printer in related art. The printer receives the print data converted by the proxy server to execute printing.

### CITATION LIST

### Patent Literature

PTL 1 Japanese Patent Laid-Open No. 2013-12066

When printing via the cloud server is performed by using the printer in related art which is not capable of interpreting the print data transmitted from the cloud server, the proxy server is to execute conversion of print data. However, the print data received by the proxy server from the cloud server may include a print setting on which the conversion is not executable by the proxy server.

When the user sets, by a client terminal, a setting item on which the conversion is not executable by the proxy server, output may be performed under a setting that is not intended by the user.

### SUMMARY OF INVENTION

In view of the above, various embodiments of the present disclosure have been made to address the above-mentioned issue, and an aspect of various embodiments aims at suppressing a situation where a print setting under which desired output may not be obtained by a printer at an output destination is set by a client terminal.

An information processing apparatus according to an aspect described in this specification includes a selection unit configured to select a print queue to be used from among print queues registered in a server system, a control unit configured to display, when a print queue is selected in which print data transmitted by the server system is to be received without intermediation of another server system configured to convert a format of the print data, a print setting screen with which a predetermined setting item is allowed to be set, and to display, when a print queue is selected in which the print data is to be received via the other server system, a print setting screen with which the predetermined setting item is not allowed to be set, and a transmission unit configured to transmit, to the server system, print data based on a print setting which has been set via the print setting screen.

Further features of the present invention will become apparent from the following description of exemplary embodiments with reference to the attached drawings.

### BRIEF DESCRIPTION OF DRAWINGS

FIG. 1 illustrates an example of a system configuration according to an embodiment described in the present specification.

FIG. 2A illustrates an example of a hardware configuration of each apparatus according to the embodiment described in the present specification.

FIG. 2B illustrates an example of a hardware configuration of each apparatus according to the embodiment described in the present specification.

FIG. 2C illustrates an example of a hardware configuration of each apparatus according to the embodiment described in the present specification.

FIG. 2D illustrates an example of a hardware configuration of each apparatus according to the embodiment described in the present specification.

FIG. 2E illustrates an example of a hardware configuration of each apparatus according to the embodiment described in the present specification.

FIG. 3A illustrates an example of a software configuration of each apparatus according to the embodiment described in the present specification.

FIG. 3B illustrates an example of a software configuration of each apparatus according to the embodiment described in the present specification.

FIG. 3C illustrates an example of a software configuration of each apparatus according to the embodiment described in the present specification.

FIG. 3D illustrates an example of a software configuration of each apparatus according to the embodiment described in the present specification.

FIG. 3E illustrates an example of a software configuration of each apparatus according to the embodiment described in the present specification.

FIG. 4 illustrates an example of a print setting screen according to the embodiment described in the present specification.

FIG. 5A illustrates an example of an extension print setting screen according to the embodiment described in the present specification.

FIG. 5B illustrates an example of the extension print setting screen according to the embodiment described in the present specification.

FIG. 5C illustrates an example of the extension print setting screen according to the embodiment described in the present specification.

FIG. 5D illustrates an example of the extension print setting screen according to the embodiment described in the present specification.

FIG. 6A illustrates an example of a data structure according to the embodiment described in the present specification.

FIG. 6B illustrates an example of the data structure according to the embodiment described in the present specification.

FIG. 6C illustrates an example of the data structure according to the embodiment described in the present specification.

FIG. 6D illustrates an example of the data structure according to the embodiment described in the present specification.

FIG. 6E illustrates an example of the data structure according to the embodiment described in the present specification.

FIG. 6F illustrates an example of the data structure according to the embodiment described in the present specification.

FIG. 6G illustrates an example of the data structure according to the embodiment described in the present specification.

FIG. 7A is a sequence diagram illustrating processing for registering printer information in a cloud print service according to the embodiment described in the present specification.

FIG. 7B is a sequence diagram illustrating the processing for registering the printer information in the cloud print service according to the embodiment described in the present specification.

FIG. 8A is a flowchart illustrating processing for the cloud print service to generate a print queue according to the embodiment described in the present specification.

FIG. 8B is a flowchart illustrating the processing for the cloud print service to generate the print queue according to the embodiment described in the present specification.

FIG. 9 is a sequence diagram illustrating processing up to execution of printing by using a cloud print compatible printer according to a first embodiment described in the present specification.

FIG. 10 is a sequence diagram illustrating processing up to execution of printing by using a cloud print non-compatible printer according to the first embodiment described in the present specification.

FIG. 11 is a flowchart illustrating processing when the extension print setting screen is displayed according to the first embodiment described in the present specification.

FIG. 12 is a sequence diagram illustrating the processing up to the execution of printing by using the cloud print compatible printer according to a second embodiment described in the present specification.

FIG. 13 is a sequence diagram illustrating the processing up to the execution of printing by using the cloud print non-compatible printer according to the second embodiment described in the present specification.

FIG. 14 is a flowchart illustrating processing when the extension print setting screen is displayed according to the second embodiment described in the present specification.

FIG. 15 is a flowchart illustrating processing when the extension print setting screen is displayed according to a third embodiment described in the present specification.

FIG. 16 illustrates an example of a sequence when a print queue is generated in a client terminal according to the embodiment described in the present specification.

### DESCRIPTION OF EMBODIMENTS

Hereinafter, embodiments for carrying out the present invention will be described with reference to the drawings.

### First Embodiment

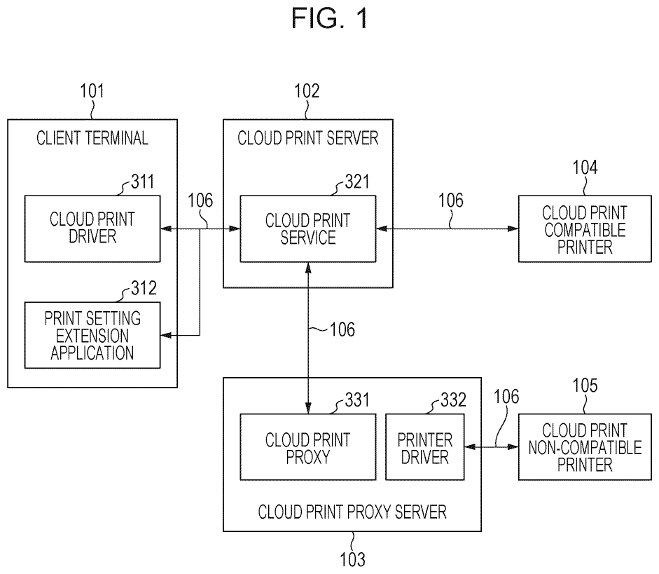

FIG. 1 is a configuration diagram illustrating a print system in cloud print according to the present embodiment. A client terminal 101, a cloud print server 102, a cloud print proxy server 103, a cloud print compatible printer 104, and a cloud print non-compatible printer 105 are connected via a network 106.

In FIG. 1, one each of the client terminal 101, the cloud print compatible printer 104, and the cloud print non-compatible printer 105 has been described, but a plurality of these respective components may be used.

The cloud print server 102 and the cloud print proxy server 103 may be a system server constituted by a single information processing apparatus, or may also be a system server constituted by a plurality of information processing apparatuses. Processing load can be distributed when each server is constituted by a plurality of information processing apparatuses. In addition, a single physical server may be configured to play a role of each server internally in a virtual manner.

A WAN such as the internet is supposed as the network 106, but a closed environment such as an in-house LAN for a company may also be used.

A PC, tablet, or smartphone which is manipulated by a user is configured to operate as the client terminal 101. Any application software can be executed on the client terminal 101. A cloud print driver 311 and a print setting extension application 312 are installed in the client terminal 101.

The cloud print compatible printer 104 and the cloud print non-compatible printer 105 are devices configured to actually perform printing on a physical sheet. The cloud print compatible printer 104 and the cloud print non-compatible printer 105 receive print data transmitted by the cloud print server 102 via the network 106 and convert the print data into image data to be printed. The cloud print compatible printer 104 is a printer capable of communicating with the cloud print server 102 in a predetermined protocol. The predetermined protocol refers to Internet Printing Protocol (IPP), for example. The cloud print non-compatible printer 105 is a printer that is not capable of performing communication in the predetermined protocol. In view of the above, when printing via could print is to be performed by using the cloud print non-compatible printer 105, the cloud print non-compatible printer 105 performs communication via the cloud print proxy server 103.

The cloud print server 102 plays a role of receiving print data constituted by a print setting and image data from the client terminal 101, and transmitting the received print data to the cloud print compatible printer 104 or the cloud print proxy server 103. A cloud print service 321 is configured to operate on the cloud print server 102.

The cloud print proxy server 103 is configured to perform communication with the cloud print server 102 instead of the cloud print non-compatible printer 105, and to perform exchange such as transmission and reception of printer information and print data. A cloud print proxy 331 and a printer driver 332 are installed in the cloud print proxy server 103.

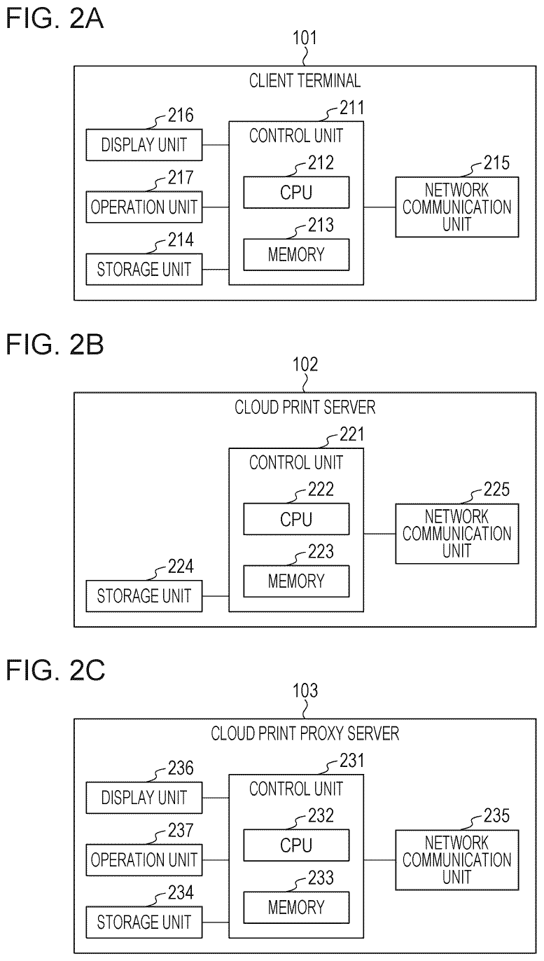

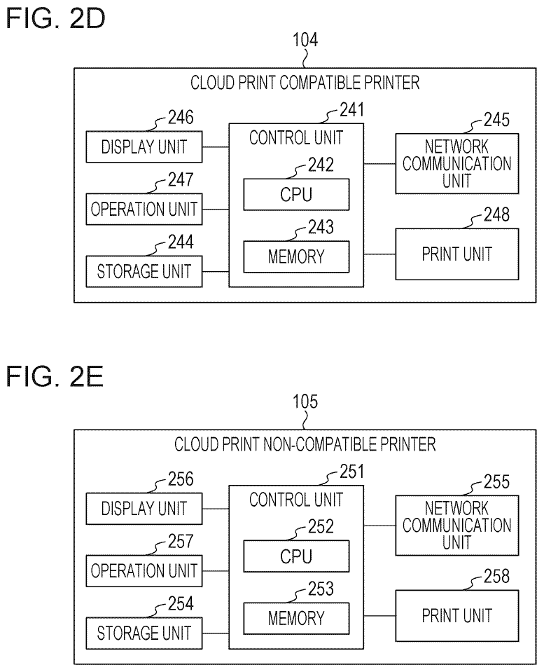

Next, a hardware configuration in the system of the present embodiment will be described with reference to FIGS. 2A to 2E.

FIG. 2A is a block diagram illustrating a hardware configuration of the client terminal 101. The client terminal 101 includes a display unit 216, an operation unit 217, a storage unit 214, a control unit 211, and a network communication unit 215.

The storage unit 214 refers to a non-volatile storage device such as a hard disc or an SSD, and can save and rewrite digital data.

The control unit 211 is constituted by a CPU 212 and a memory 213, and configured to control an entire operation of the client terminal 101. The CPU 212 is configured to expand a program stored in the storage unit 214 into the memory 213 to execute the program. The memory 213 is a main storage memory of the CPU 212, and is used as a work area or a temporary storage area for expanding various types of programs.

The network communication unit 215 is an apparatus configured to perform communication with the external network 106, and to perform input and output of digital data with an external server, client terminal, or the like via the network 106.

The display unit 216 is an apparatus such as a liquid crystal display configured to display visual information for the user.

The operation unit 217 is an apparatus configured to accept an entry from the user by way of a keyboard, a mouse, or the like. An apparatus such as a touch panel which has functions of both the display unit 216 and the operation unit 217 may also be used.

FIG. 2B is a block diagram illustrating a hardware configuration of the cloud print server 102. The cloud print server 102 includes a storage unit 224, a control unit 221, and a network communication unit 225. Descriptions of the storage unit 224, the control unit 221, the network communication unit 225 are equivalent to the descriptions of those of the client terminal 101, and are therefore omitted. It is noted that in FIG. 2B, one each of the storage unit 224, the control unit 221, and the network communication unit 225 has been described, but a configuration of including one or a plurality of those respective components may also be adopted.

FIG. 2C is a block diagram illustrating a hardware configuration of the cloud print proxy server 103. The cloud print proxy server 103 includes a display unit 236, an operation unit 237, a storage unit 234, a control unit 231, and a network communication unit 235. Descriptions of the display unit 236, the operation unit 237, the storage unit 234, the control unit 231, and the network communication unit 235 are equivalent to the descriptions of those of the client terminal 101, and are therefore omitted. In FIG. 2C, one each of the display unit 236, the operation unit 237, the storage unit 234, the control unit 231, and the network communication unit 235 has been described, but one or a plurality of these respective components may be used.

FIG. 2D is a block diagram illustrating a hardware configuration of the cloud print compatible printer 104. The cloud print compatible printer 104 includes a display unit 246, an operation unit 247, a storage unit 244, a control unit 241, a network communication unit 245, and a print unit 248.

The display unit 246 is an apparatus such as a touch panel or LED embedded in the cloud print compatible printer 104 which is configured to display information for the user in real time.

The operation unit 247 is an apparatus configured to accept an entry from the user, and may also include hard keys such as numeric keys in addition to the touch panel. The storage unit 244 and the control unit 241 are equivalent to those of the client terminal 101, and descriptions thereof are therefore omitted. It is noted that a configuration including one or a plurality of storage units 244 and one or a plurality of the control units 241 may also be adopted.

The network communication unit 245 is an apparatus configured to communicate with the external network 106, and has a role of mainly receiving print data and transmitting a state of the cloud print compatible printer 104 such as an error towards an external server or the like.

The print unit 248 is an apparatus configured to perform print processing by performing a series of operations including sheet feed, printing, and sheet discharge for a sheet prepared in a cassette or tray. A printing method is not particularly limited, and may be an electrophotography method, an ink jet method, or the like. A duplex unit, a staple, and a finishing apparatus for punch processing or the like which are used when the sheet is discharged are also included in the print unit 248.

It is noted that according to the present embodiment, a single function printer configured to implementing a print function alone is described as an example of the cloud print compatible printer 104, but a multi function printer (multi function peripheral) having a scanner function and a FAX function in addition to the print function may also be used.

FIG. 2E is a block diagram illustrating a hardware configuration of the cloud print non-compatible printer 105. The cloud print non-compatible printer 105 includes a display unit 256, an operation unit 257, a storage unit 254, a control unit 251, a network communication unit 255, and a print unit 258.

Descriptions of the display unit 256, the operation unit 257, the storage unit 254, the control unit 251, the network communication unit 255, and the print unit 258 are equivalent to the descriptions of those of the cloud print compatible printer 104, and are therefore omitted.

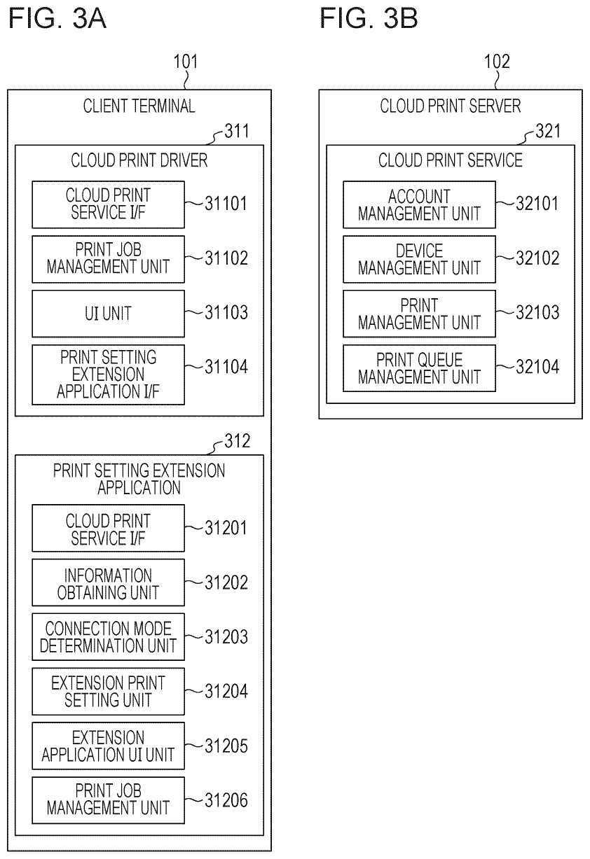

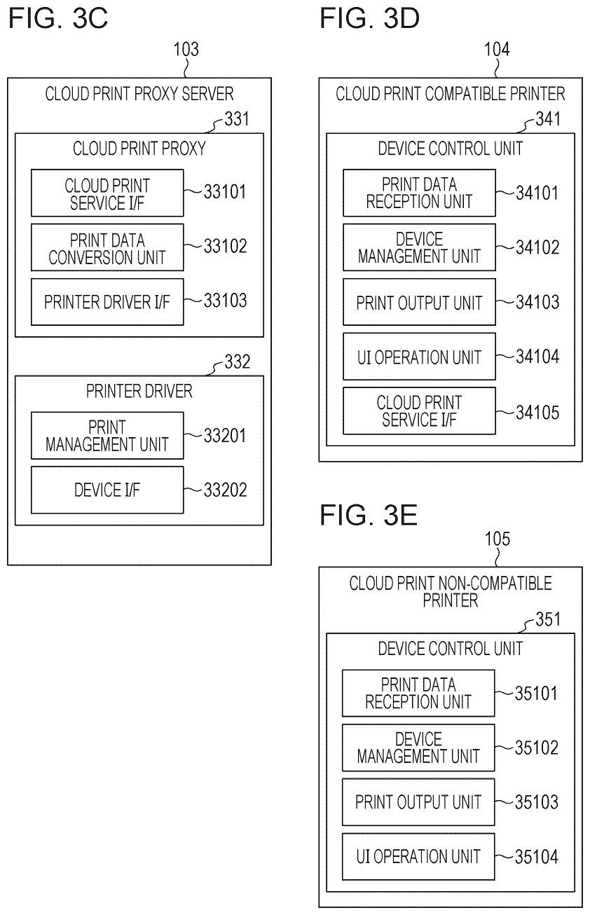

Next, a software configuration in the system of the present embodiment will be described with reference to FIGS. 3A to 3E.

FIG. 3A is a block diagram illustrating a software configuration of the client terminal 101.

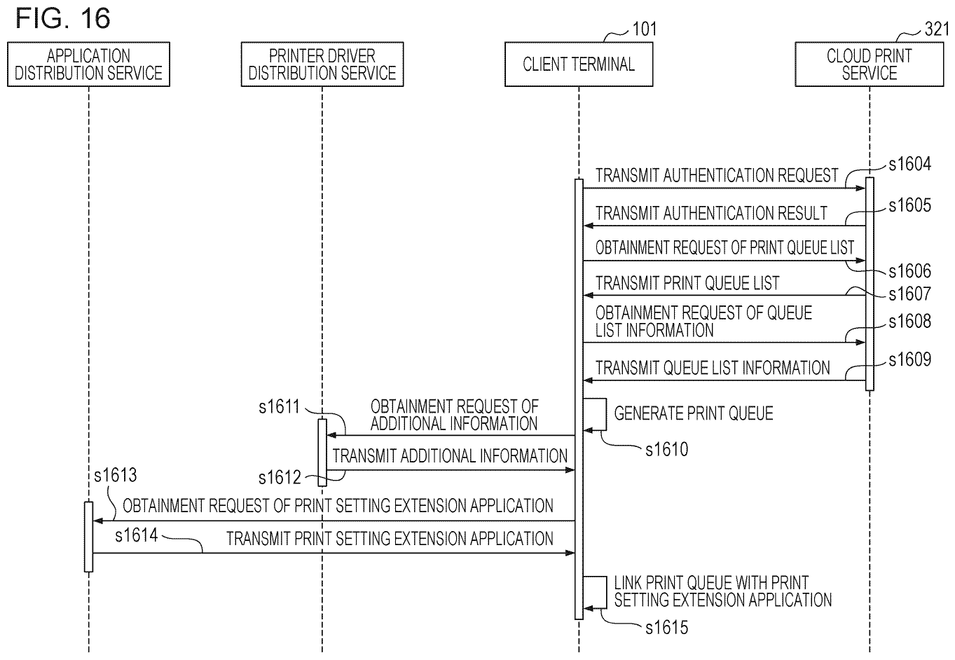

The client terminal 101 includes the cloud print driver 311 and the print setting extension application 312. The cloud print driver 311 is software configured to generate print data to be transmitted to the cloud print server 102. The print setting extension application 312 is an application configured to extend a function of the cloud print driver 311, and to execute processing such as display control of a print setting screen. It is noted that the cloud print driver 311 is downloaded by the user from a website provided by the cloud print service 321, and installed into the client terminal 101. Timing at which the print setting extension application 312 is downloaded and installed into the client terminal 101 will be described below with reference to FIG. 16.

The cloud print driver 311 further has the following software configuration.

A cloud print service interface (I/F) 31101 is configured to process exchange of data and commands with the cloud print service 321.

A print job management unit 31102 is configured to perform processing such as generation of a print job and transmission of the print job. The print job management unit 31102 generates print data in accordance with a protocol which is supported by the cloud print service 321, and transmits the print data as a print job. For example, when the cloud print service performs transmission and reception of the print data in accordance with IPP, such print data is generated that a print setting is in accordance with IPP. In addition, with regard to a file format of image data included in the print data, the print data is generated in accordance with a file format (for example, PDF or PWG-Raster) which is supported by the cloud print service.

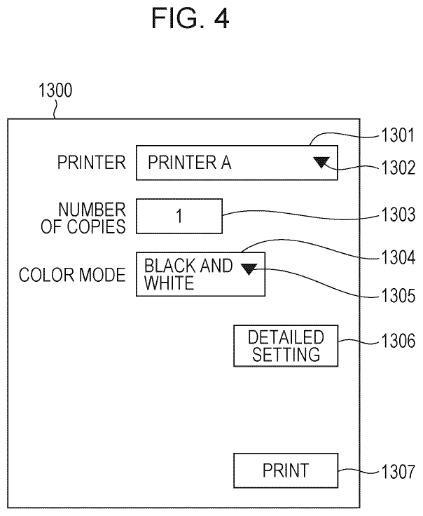

A UI unit 31103 has a role such as displaying a user interface (UI) prepared by the cloud print driver 311 or accepting an operation of the user from the client terminal 101. The UI unit 31103 is configured to display a print setting screen 1300 illustrated in FIG. 4. An object configured to perform printing in printing using the cloud print service 321 is arranged on the print setting screen 1300. Information of the print queue registered in the cloud print server 102 is displayed in a field 1301 in FIG. 4. A button 1302 is a button for displaying a list of print queues registered in the cloud print server 102. The user selects the button 1302 to select a print queue corresponding to a printer to be used for printing from among the displayed print queues. A field 1303 is a field for setting the number of copies to be printed. A field 1304 is a field for setting a color mode. A button 1305 is a button for changing the color mode, and after the user has selected the button 1305, the color mode at the time of printing can be selected. A detail setting button 1306 is a button for activating the print setting extension application 312. A print button 1307 is a button for transmitting a print instruction to the cloud print server 102. When the user selects the print button 1307, the print job management unit 31102 generates a print job. The generated print job is transmitted to the cloud print service 321 via the cloud print service I/F 31101.

It is noted that according to the present embodiment, descriptions have been provided where the cloud print driver 311 includes the UI unit 31103 to display the print setting screen 1300. An operation system (OS) of the client terminal 101 or an application installed in the client terminal 101 may include the UI unit to display the print setting screen 1300. In the above-mentioned case, in addition to the print queues registered in the cloud print server 102, a print queue in which the client terminal 101 can directly transmit the print data is displayed in the field 1301. When the print queue in which the client terminal 101 can directly transmit the print data is selected, the client terminal 101 generates the print data by a printer driver corresponding to the selected print queue. The generated print data is transmitted to a printer without intermediation of the cloud print server 102.

A print setting extension application I/F 31204 is configured to process exchange of data and commands with the print setting extension application 312.

The print setting extension application 312 further has the following software configuration.

The cloud print service I/F 31201 is configured to process exchange of data and commands with the cloud print service 321. The cloud print service I/F 31201 obtains, from the print setting extension application I/F 31104 of the cloud print driver 311, information of the printer set on the print setting screen 1300 and the print setting. In addition, the cloud print service I/F 31201 plays a role of transferring the print setting set in the print setting extension application 312 to the cloud print driver 311.

An information obtaining unit 31202 is configured to obtain information such as print queue information from the cloud print service 321.

A connection mode determination unit 31203 is configured to determine whether the printer corresponding to the print queue to be used for printing is a printer directly connected to the cloud print service 321 or a printer connected via the cloud print proxy 331. The connection mode determination unit 31203 obtains print queue information selected in the field 1301 from the cloud print driver 311 and performs determination based on the information.

An extension print setting unit 31204 is configured to manage a print setting including a printer vendor specific print setting which is not supported by the cloud print driver 311.

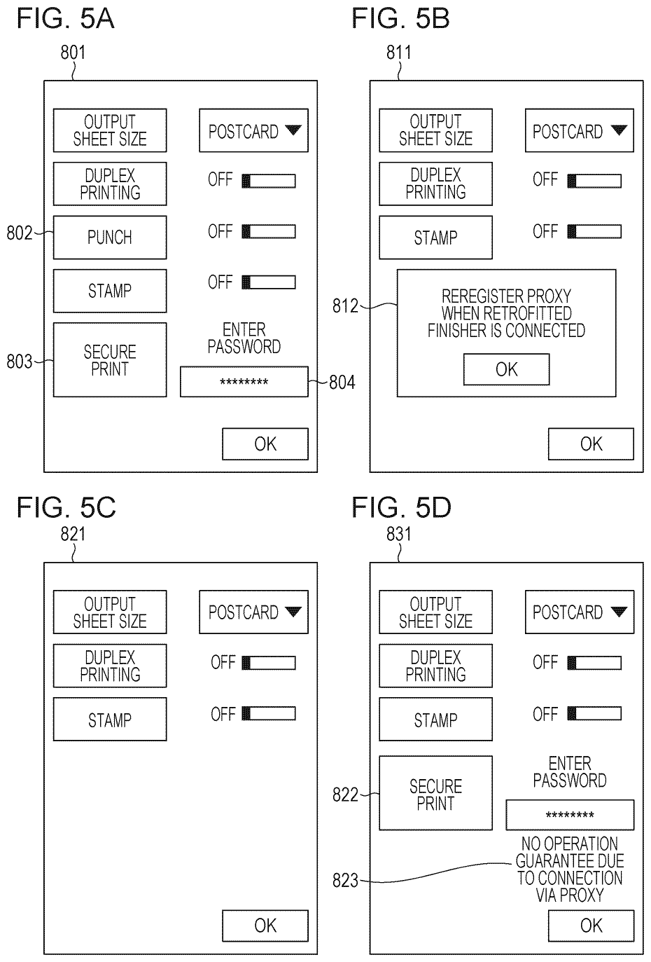

An extension application UI unit 31205 plays a role of displaying a UI prepared by the print setting extension application, accepting an operation of the user from the client terminal 101, or the like. FIG. 5A illustrates an example of a print setting UI displayed by the extension application UI unit 31205 of the print setting extension application 312. An extension print setting screen 801 is a screen to be displayed when the user selects the detail setting button 1306 on the print setting screen 1300. Print settings which are not allowed to be set on the print setting screen 1300 can be set on the extension print setting screen 801. For example, a field 802 is a field for setting whether or not a punch hole is made in a sheet to be output. When the user selects the field 802, on and off of the punch setting are switched. Herein, off means that no punch hole is made in the sheet, and on means that the punch hole is made in the sheet. Secure print 803 is a function with which printing is to be started when a password that has been set by the print setting extension application 312 is entered to the printer. A field 804 is a field for entering a password used at the time of printing when the secure print function is used. After the user issues a print instruction, when a password same as the password entered in the field 804 is entered to the printer, the printer starts printing. In addition to the above-mentioned setting items, fields for performing a setting on an output sheet size used for output, a setting on whether or not duplex printing is to be performed, and a setting related to a stamp function of attaching a predetermined image to a sheet to be printed are provided on the extension print setting screen 801. When the user selects an “OK” button, the extension print setting screen 801 is closed, and the print setting screen 1300 is displayed.

It is noted that according to the present embodiment, only the setting items which are not allowed to be set on the print setting screen 1300 are displayed on the extension print setting screen 801. A configuration may also be adopted where setting items which are allowed to be set on the print setting screen are also displayed on the extension print setting screen 801, and setting of those setting items can also be changed.

A print job management unit 31206 is configured to perform processing such as generation of a print job, editing of the print job generated by the cloud print driver 311, or transmission of the print job. The print job management unit 31206 of the print setting extension application 312 can edit the print job generated by the print job management unit 31102 of the cloud print driver 311.

FIG. 3B is a block diagram illustrating a software configuration of the cloud print service 321 operating on the cloud print server 102.

A account management unit 32101 is configured to manage authentication of tenants and users which have been already registered in the cloud print service 321. A tenant is a group to which one or a plurality of users belong. The account management unit 32101 links and manages a user ID of each user and information such as a password used for the authentication. Furthermore, the account management unit 32101 manages the user ID and a tenant ID to which the user belongs in association with each other.

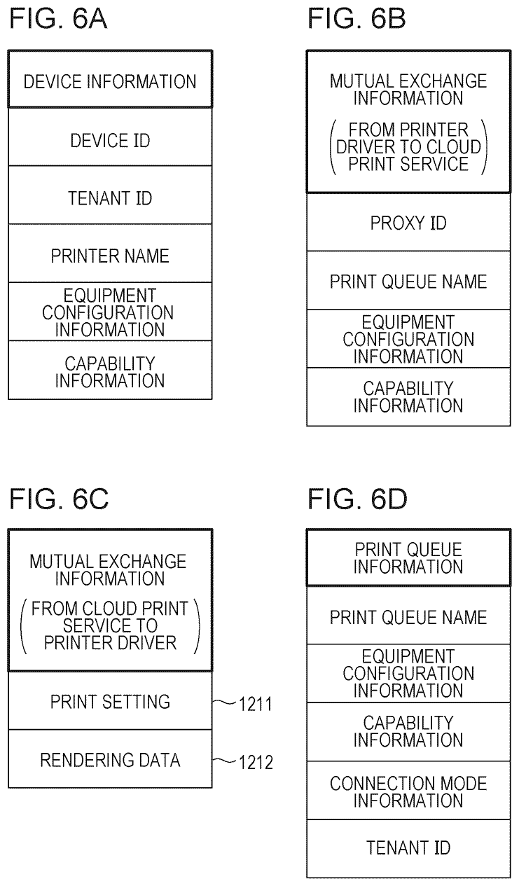

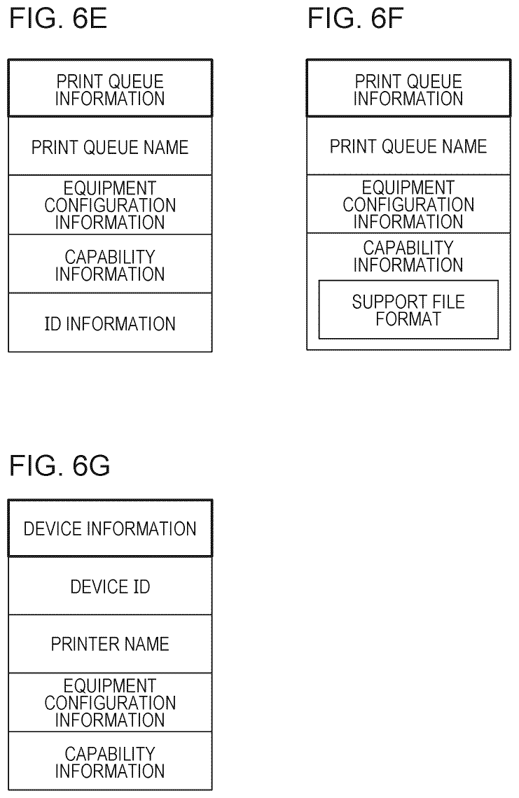

A device management unit 32102 is configured to manage information related to the printers already registered in the cloud print service 321. Device information is registered in the device management unit 32102 by a registration request from the printer. FIG. 6A illustrates an example of the device information registered in the device management unit 32102. A device ID is identification information for identifying a printer, and is, for example, hardware identification information (hardware ID) of the printer or the like. The tenant ID is identification information of a tenant that can use the device. A printer name is a name of the device which is notified from the printer. Equipment configuration information is configuration information of the printer, and is information on whether a finisher configured to perform post processing such as stapling or punching is connected to the printer, information on whether a unit configured to perform duplex printing is connected, or the like. Capability information is information indicating a function that the printer can execute. The capability information includes information on whether or not color printing can be performed, information on whether or not duplex printing can be performed, information on a position where stapling can be performed, information on a punch hole that can be used, information on whether or not the secure print function can be used, or the like.

A print management unit 32103 is configured to perform, for a print job delivery request from the cloud print compatible printer 104 or the cloud print proxy server 103, determination on whether or not a permission is given, management of delivery of the print job, or the like.

A print queue management unit 32104 is configured to receive a print job from the outside, and to hold the received print job in an area prepared in the storage unit 224 of the cloud print server 102. The print queue management unit 32104 manages print queue information described in FIG. 6D. The print queue information includes a print queue name, the equipment configuration information, the capability information, connection mode information, and the tenant ID. The print queue name is a name of the print queue, and is a name to be displayed on the print setting screen 1300. The equipment configuration information and the capability information are information similar to the device information in FIG. 6A. The connection mode information is information indicating whether the print queue is a queue in which the print data is to be transmitted to the printer without intermediation of the cloud print proxy server 103 or a queue in which the print data is to be transmitted to the cloud print proxy server 103. The tenant ID is identification information of the tenant that can use the print queue. The device information described in FIG. 6A and the print queue information described in FIG. 6D are linked with each other while the tenant ID is set as a key. The device ID is similar to the device ID in FIG. 6A, and is information for identifying the printer associated with the print queue. For example, a hardware ID (HWID) for identifying hardware of the printer is registered as the device ID.

FIG. 3C is a block diagram illustrating a software configuration of the cloud print proxy server 103. The cloud print proxy server 103 includes the cloud print proxy 331 and the printer driver 332.

The cloud print proxy 331 further has the following software configuration.

A cloud print service I/F 33101 is configured to process exchange of data and commands which is performed with the cloud print service 321.

A print data conversion unit 33102 is configured to perform conversion of data to be exchanged between the cloud print service 321 and the printer driver 332 when necessary.

A printer driver I/F 33103 is configured to process exchange of data and commands which is performed with the printer driver 332.

In addition, the printer driver 332 has the following software configuration.

The print management unit 33201 is configured to convert the print data including the print setting received from the cloud print proxy 331 and rendering data into a page description language (PDL) that can be processed by the printer, and to transmit the converted data to the printer.

A device I/F 33202 is configured to process exchange of data and commands which is performed between the printer driver 332 and the cloud print non-compatible printer 105.

In addition, a print management unit 33201 is configured to manage the capability information of the cloud print non-compatible printer 105 associated with the printer driver 332. The capability information managed by the print management unit 33201 is converted by the print data conversion unit 33102 of the cloud print proxy 331 into mutual exchange information that can be interpreted by the cloud print server 102, and the cloud print server 102 is notified of the mutual exchange information. FIG. 6B illustrates an example of the mutual exchange information generated by the print data conversion unit 33102. The mutual exchange information includes a proxy ID, a print queue name, the equipment configuration information, and the capability information. The proxy ID is identification information of the cloud print proxy 331. The print queue name is a name of the print queue linked with the printer driver 332 on the cloud print proxy server 103. The equipment configuration information is configuration information of the cloud print non-compatible printer 105 corresponding to the printer driver 332. The capability information is capability information of the cloud print non-compatible printer 105 corresponding to the printer driver 332. As described above, in the case of the intermediation of the cloud print proxy server 103, the cloud print server 102 is notified of the proxy ID instead of the device ID.

The mutual exchange information described in FIG. 6C is an example of the print data notified from the cloud print server 102 to the print data conversion unit 33102. This mutual exchange information includes the print setting 1211 and the rendering data 1212. The print data conversion unit 33102 converts the mutual exchange information described in FIG. 6C into a format that can be dealt with by the printer driver 332, and delivers the converted mutual exchange information to the printer driver 332.

FIG. 3D is a block diagram illustrating a software configuration of a device control unit 341 of the cloud print compatible printer 104.

A print data reception unit 34101 is configured to accept the print data transmitted from the outside via the network 106 to be stored in the storage unit 244 of the cloud print compatible printer 104. The print data reception unit 34101 can process the print data in a predetermined protocol which can be generated by the cloud print server 102.

A device management unit 34102 is configured to manage an option connected to the cloud print compatible printer 104, the capability information, a remaining sheet amount, a remaining ink/toner amount, or the like. The device management unit 34102 can generate capability information that can be interpreted by the cloud print server 102.

A print output unit 34103 is configured to control printing on the sheet.

An UI operation unit 34104 is configured to display an UI to the operation unit 247 of the cloud print compatible printer 104, and obtains an instruction or information entered via the UI.

A cloud print service I/F 34105 is configured to process exchange of data and commands which is performed with the cloud print service 321.

FIG. 3E is a block diagram illustrating a software configuration of a device control unit 351 of the cloud print non-compatible printer 105.

A print data reception unit 35101 is configured to receive the print data from the device I/F 33202 of the printer driver 332. The print data reception unit 35101 is not supporting a format of the print data transmitted by the cloud print server 102, and the print data is not to be interpreted. According to the present embodiment, the print data transmitted by the cloud print server 102 is converted into a format that can be processed by the print data reception unit 35101 by using the printer driver of the cloud print proxy server 103. With the above-mentioned configuration, printing via the cloud print server 102 can be realized by using the cloud print non-compatible printer 105.

A device management unit 35102 is configured to manage the capability information, the remaining sheet amount, and the remaining ink/toner amount of the cloud print non-compatible printer 105. The device management unit 35102 manages the above-mentioned information in a format different from that of the cloud print server 102. For this reason, conversion by the cloud print proxy server 103 is to be used to notify the cloud print server 102 of the capability information of the cloud print non-compatible printer 105.

Descriptions of a print output unit 35103 and a UI operation unit 35104 are equivalent to those of the cloud print compatible printer 104, and are therefore omitted.

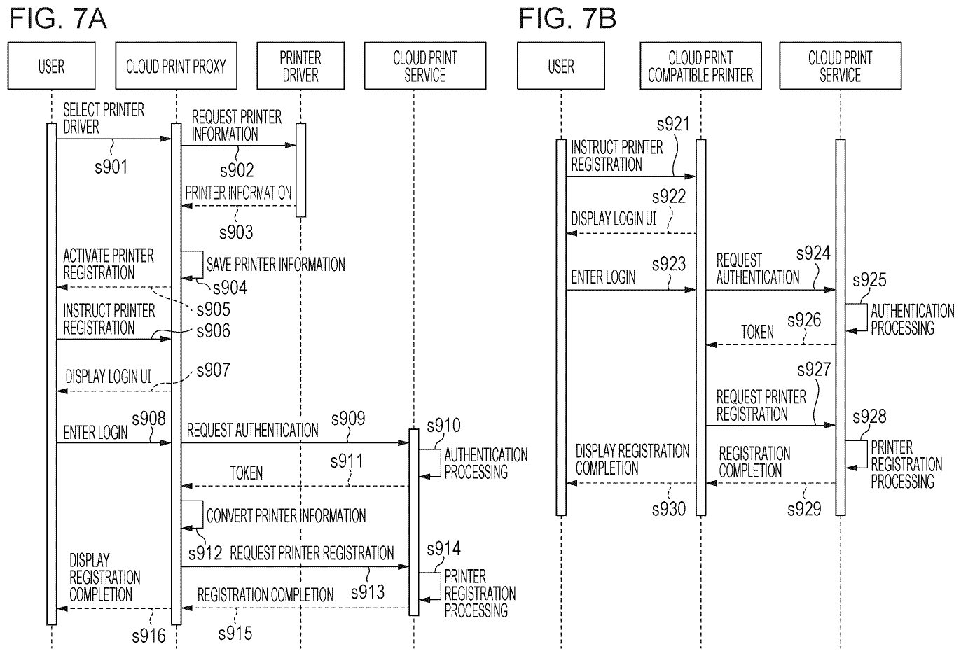

Next, with reference to FIG. 7B, an example of a procedure of the user and a sequence between each software and the service with regard to registration of the cloud print compatible printer 104 into the cloud print service 321 according to the present embodiment will be described.

First, the user instructs a printer registration from the operation unit 247 of the cloud print compatible printer 104 (s921).

Next, the cloud print compatible printer 104 displays a login UI to the cloud print service 321 on the operation unit 247 (s922).

Next, the user enters login information to the login UI (s923). The login information refers to a user ID and a password.

Next, the cloud print compatible printer 104 transmits the entered login information and an authentication request to the cloud print service 321 (s924).

Next, the cloud print service 321 performs authentication processing based on the login information received together with the authentication request (s925). When the authentication is successful, the cloud print service 321 issues a token for access, and transmits the token to the cloud print compatible printer 104 (s926). This token is a token to be used when the cloud print compatible printer 104 accesses the cloud print service 321 from the next time. It is noted that in s925, when the authentication fails, the sequence illustrated in FIG. 7B ends.

Next, the cloud print compatible printer 104 transmits a printer registration request to the cloud print service 321 together with the received token and the printer information (s927).

The cloud print service 321 executes printer registration processing (s928). A detail of the printer registration processing executed in s928 will be described below.

Next, after the printer registration processing, the cloud print service 321 returns a registration completion status to the cloud print compatible printer 104 (s929). Then, the cloud print compatible printer 104 displays the registration completion status on the operation unit 247 (s930).

Next, with reference to FIG. 7A, an example of a procedure of the user and a sequence between each software and the service with regard to registration of the cloud print non-compatible printer into the cloud print service according to the present embodiment will be described. Note that it is assumed that the printer driver 332 is installed in the cloud print proxy server 103, and a print queue corresponding to the cloud print non-compatible printer 105 is generated. When the print queue is generated, the printer driver 332 communicates with the cloud print non-compatible printer 105, and obtains the hardware ID, a model name, the equipment configuration information, and the capability information of the printer.

First, the user selects the printer driver 332 for the cloud print non-compatible printer 105 to be connected in the cloud print proxy 331 (s901).

Next, the cloud print proxy 331 requests the selected printer driver 332 for the printer information (s902). The printer information refers to the hardware ID, the model name, the equipment configuration information, and the capability information that can be set of the printer, and the like.

Next, the printer driver 332 returns the printer information to the cloud print proxy 331 (s903).

Herein, a method of obtaining an HWID of the printer that is one of the printer information according to the present embodiment will be described. The cloud print proxy 331 calls an OpenPrinter ( ) function of Win32API to obtain a printer handle of the printer driver 332 which has been selected in s901 described above. Next, a GetPrinterDriver ( ) function is called by using the obtained printer handle of the printer driver 332 to obtain DRIVER_INFO_6. A DRIVER_INFO_6 structure is generated when the print queue is generated in the cloud print proxy server 103. The DRIVER_INFO_6 structure is data including the information of the printer driver, and is specifically filled with information linked with the printer driver such as a printer driver name and an install path of the printer driver. This DRIVER_INFO_6 includes a value called pszHardwareID, and an HWID of the printer driver is stored. The cloud print proxy 331 can obtain the HWID of the printer driver 332 by obtaining the HWID stored in DRIVER_INFO_6.

According to the present embodiment, the hardware ID of the printer is obtained by using Win32API, but any method may be adopted as long as the hardware ID can be obtained.

Next, the cloud print proxy 331 saves the received printer information in association with the printer driver 332 (s904).

Next, the cloud print proxy 331 enables a printer registration button on the UI to indicate that the printer registration is enabled (s905).

Next, the user presses the printer registration button to instruct the printer registration (s906).

Next, the cloud print proxy 331 displays the login UI to the cloud print service 321 on the UI (s907).

Next, the user enters the login information to the login UI (s908).

Next, the cloud print proxy 331 transits the authentication request to the cloud print service 321 together with the entered login information (s909).

Next, the cloud print service 321 performs the authentication processing (s910). When the authentication is successful, the cloud print service 321 issues a token for access and returns the token to the cloud print proxy 331 (s911). It is noted that when the authentication fails, the processing described in FIG. 7A is ended.

Next, the cloud print proxy 331 converts the data format of the saved printer information into a format that can be dealt with by the cloud print service 321 (s912).

The format that can be dealt with by the cloud print service 321 is, for example, a format in accordance with IPP.

Then, the cloud print proxy 331 transmits the printer registration request to the cloud print service 321 together with the received token and the printer information after the conversion (s913).

Next, the cloud print service 321 performs the printer registration processing (s914). A detail of the printer registration processing will be described below.

Next, after the printer registration processing, the cloud print service 321 returns the registration completion status to the cloud print proxy 331 (s915).

Then, the cloud print proxy 331 displays the registration completion status on the UI (s916).

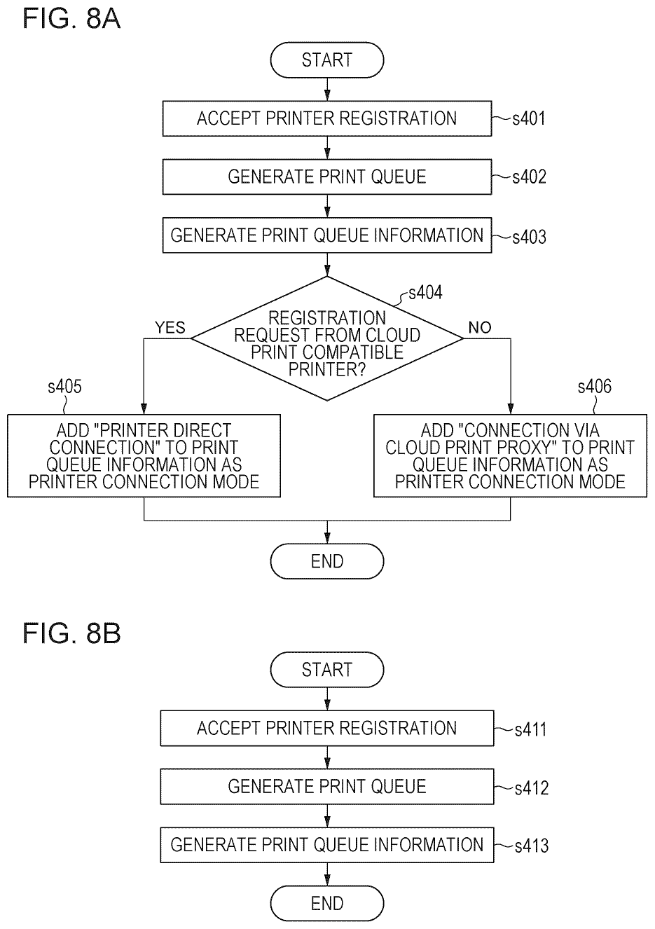

FIG. 8A is a flowchart illustrating an example of the printer registration processing executed by the cloud print service 321 in s914 in FIG. 7A and in s928 in FIG. 7B.

The processing illustrated in FIG. 8A is realized when a program of the cloud print service 321 which is stored in the storage unit 224 of the cloud print server 102 is loaded onto a memory 223 to be executed by a CPU 222.

The processing described in FIG. 8A is started as a result of reception of the printer registration request by the cloud print service 321 from the outside via the network 106.

First, the device management unit 32102 of the cloud print service 321 accepts a printer registration request (s401). The registration request of the printer includes the device information illustrated in FIG. 6G or the mutual exchange information illustrated in FIG. 6B. The device management unit 32102 generates the device information illustrated in FIG. 6A based on the received device information or the mutual exchange information and the tenant ID corresponding to the currently logged-in user.

The print queue management unit 32104 generates a print queue based on the generated device information (s402).

Next, the print queue management unit 32104 generates the print queue information illustrated in FIG. 6D (s403). When the information received together with the registration request is the device information illustrated in FIG. 6G, the printer name is set as the print queue name. When the information received together with the registration request is the mutual exchange information illustrated in FIG. 6B, the print queue name in the mutual exchange information is set as the print queue name to be generated.

The print queue management unit 32104 determines whether or not the received registration request is a registration request from the cloud print compatible printer (s404). In s404, when the information received together with the registration request includes a device ID, the print queue management unit 32104 determines that the registration request is a registration request from the cloud print compatible printer 104. On the other hand, when the information received together with the registration request does not include the device ID, the print queue management unit 32104 determines that the registration request is a registration request from the cloud print non-compatible printer 105. It is noted that the determination in s404 may also be performed based on whether or not the information received together with the registration request includes a proxy ID. Whether the received device ID is a device ID of the cloud print compatible printer 104 or a proxy ID of the cloud print proxy server 103 is determined based on a character string included in the received device ID. When the received device ID includes a specific character string, it is determined that the device ID is the proxy ID of the cloud print proxy server 103. On the other hand, when the received device ID does not include the specific character string, it is determined that the device ID is the device ID of the cloud print compatible printer 104. It is noted that the determination in s404 is not limited to the above-mentioned method as long as it is possible to determine whether the printer that has transmitted the registration request is the cloud print compatible printer or the cloud print non-compatible printer connected via the proxy server.

When the received registration request is the registration request transmitted by the cloud print compatible printer 104, the print queue management unit 32104 sets information indicating “printer direct connection” as the connection mode information in the print queue information (s405).

On the other hand, when the received registration request is the registration request transmitted by the cloud print non-compatible printer 105, the print queue management unit 32104 sets information indicating “connection via cloud print proxy” as the printer connection mode in the print queue information (s406). After the above-mentioned processing, the cloud print service 321 ends the printer registration processing illustrated in FIG. 8A.

The procedure and processing for registering the printer information in the cloud print service 321 have been described above.

After the above-mentioned processing, the user performs generation processing of a print queue for inputting a print job to the client terminal 101 by using the cloud print service 321. Here, the generation processing of the print queue by the client terminal 101 will be described with reference to FIG. 16.

A sequence illustrated in FIG. 16 is started when the user operates the client terminal 101 to instruct a search for the printer registered in the cloud print service 321.

When the search instruction for the printer registered in the cloud print service 321 is accepted, the client terminal 101 transmits an authentication request to the cloud print service 321 (s1604). In s1604, first, either a user ID and password or an access token to the cloud print service 321 is transmitted from the client terminal 101 to the cloud print service 321. The cloud print service 321 authenticates the user based on the information received from the client terminal 101. Then, the cloud print service 321 transmits an authentication result to the client terminal 101 (s1605). When the received authentication result is an authentication success, the client terminal 101 executes the following processing. When the received authentication result is an authentication failure, the client terminal 101 ends the sequence illustrated in FIG. 16 without executing the following processing.

The client terminal 101 transmits an obtainment request of a print queue list to the cloud print service 321 (s1606). The cloud print service 321 specifies, based on a user ID of a logged-in user, a tenant ID of a tenant to which the user belongs. Then, the cloud print service 321 specifies device information registered in associated with the specified tenant ID. Then, the cloud print service 321 puts a printer name of the specified device information into a list to be transmitted to the client terminal 101 as the print queue list (s1607).

The client terminal 101 displays the print queue list received from the cloud print service 321 on the display unit 216. It is noted that when the print queue list is displayed, display of the print queue of the printer in which the print queue for transmitting the print job to the client terminal 101 via the cloud print service has been already created may be avoided.

Then, the client terminal 101 accepts, from the user, a selection of the print queue corresponding to the print queue generated by the client terminal 101. The client terminal 101 transmits an obtainment request of information of the selected print queue to the cloud print service 321 (s1608). The cloud print service 321 receives the obtainment request of the information of the print queue, and transmits the print queue information of the print queue selected by the user to the client terminal 101. It is noted that the print queue information transmitted herein is such information as illustrated in FIG. 6D. The capability information stores a function that the printer linked with the print queue can use and also the HWID of the printer.

The client terminal 101 generates, based on the received print queue information, a print queue for transmitting the print job into the client terminal 101 via the cloud print service 321 (s1610).

Then, the client terminal 101 transmits an obtainment request of additional information of the printer corresponding to the generated print queue to a printer driver distribution service which is not illustrated in the drawing (s1611). In s1611, to obtain additional information, the client terminal 101 transmits the HWID included in the capability information of the print queue information obtained from the cloud print service 321 to the printer driver distribution service.

The printer driver distribution service is a service provided by a server system that can be accessed by the client terminal 101 via the network 106. The server system is constituted by one or a plurality of information processing apparatuses having a hardware configuration similar to that of the cloud print server illustrated in FIG. 2B. The printer driver distribution service stores a file in which information related to a printer driver or an application for extending the printer driver is described, or the like. For example, identification information of the print setting extension application for extending the print setting screen is described in the above-mentioned file. The printer driver distribution service stores the printer driver and the above-mentioned file in association with the HWID of the printer.

The printer driver distribution service specifies a file corresponding to the HWID received from the client terminal 101, and transmits the file to the client terminal as additional information (s1612). The client terminal 101 transmits, to an application distribution service which is not illustrated in the drawing, an obtainment request of the print setting extension application identified by the identification information of the application described in the file that is the received additional information (s1613).

The application distribution service is a service provided by a server system that can be accessed by the client terminal 101 via the network 106. The server system is constituted by one or a plurality of information processing apparatuses having a hardware configuration similar to that of the cloud print server illustrated in FIG. 2B. The application distribution service stores an application and identification information of the application in association with each other.

The application distribution service transmits, to the client terminal 101, the application identified by the identification information of the application which is received from the client terminal 101 (s1614).

The client terminal 101 stores the received application to be linked with the generated print queue (s1615). With the above-mentioned configuration, when the print setting extension application is called from the print setting screen, the application corresponding to the selected print queue can be activated.

As illustrated in FIG. 16, by obtaining the HWID of the printer linked with the print queue generated by the client terminal 101, the information of the print queue to be generated can be added from an external server, and the extension can be realized.

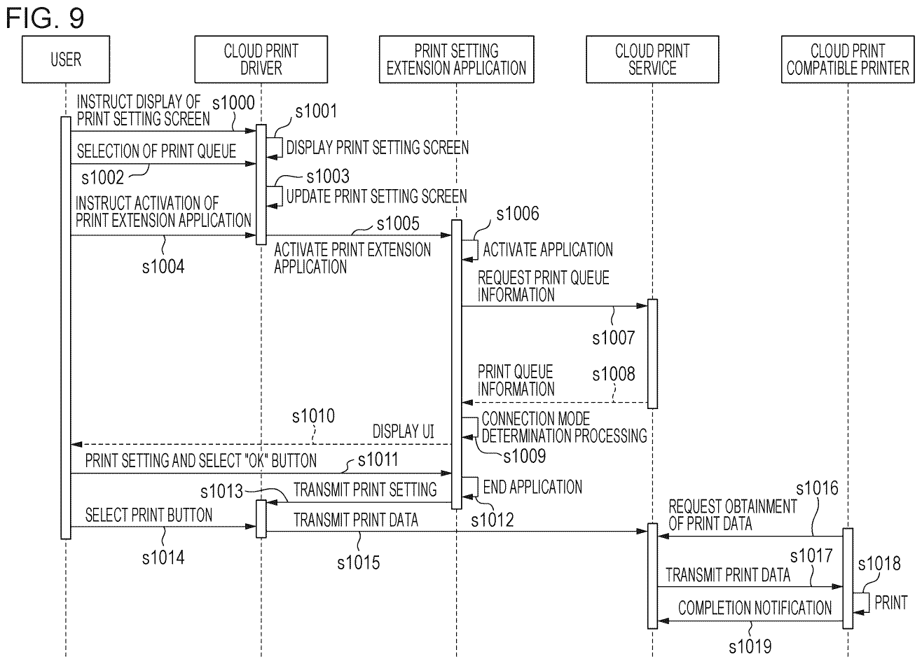

FIG. 9 illustrates an example of a sequence illustrating the print setting and processing related to the print processing according to the present embodiment. FIG. 9 is a sequence in a case where the cloud print compatible printer 104 is used.

The user issues a display instruction of the print setting screen in the application (s1000). The cloud print driver 311 accepts the display instruction of the print setting screen via the application.

The cloud print driver 311 displays the print setting screen 1300 (s1001). The print setting screen illustrated in FIG. 4 is displayed.

The user operates the field 1301 on the print setting screen 1300 to select a print queue corresponding to the printer to be used for printing (s1002).

The cloud print driver 311 refers to information of the selected print queue to update the print setting screen 1300 (s1003). Herein, the cloud print driver 311 updates the print setting screen based on the print queue information obtained in the sequence described in FIG. 16. Information to be used for the update of the print setting screen includes, for example, the capability information, the name of the print queue, the HWID, and the like. From the selected print queue information, a case is assumed where the printer linked with the print queue is a printer capable of executing both color printing and black and white printing. At this time, the cloud print driver 311 displays a print setting screen with which either color or black and white can be selected in the field 1304 in FIG. 4. On the other hand, from the print queue information of the selected print queue, a case is assumed where the printer linked with the print queue is a black and white printer. At this time, the cloud print driver 311 displays a print setting screen with which only black and white can be selected in the field 1304 in FIG. 4.

The user operates the print setting screen 1300 to instruct activation of the print setting extension application 312 (s1004). When the user selects the detail setting button 1306 on the print setting screen 1300, the cloud print driver 311 accepts an activation instruction of the print setting extension application 312 (s1005).

Next, the print setting extension application 312 performs activation processing (s1006).

Next, the print setting extension application 312 transmits an obtainment request of the print queue information to the cloud print service 321 (s1007). The cloud print service 321 transmits the print queue information (FIG. 6D) corresponding to the obtainment request received from the print setting extension application 312 to the print setting extension application 312 (s1008). The print setting extension application 312 refers to the connection mode information of the received print queue information to determine whether the printer corresponding to the selected print queue is a printer via the cloud printer proxy server (s1009). The print setting extension application 312 displays the extension print setting screen based on the determination (s1010). In FIG. 9, in s1009, since information indicating the printer direct connection has been attached to the print queue information, the print setting extension application 312 displays the UI illustrated in FIG. 5A.

The user operates the print setting extension application 312 to perform the print setting and select the “OK” button (s1011). The print setting extension application 312 executes processing for ending the application (s1012). Then, the print setting extension application 312 transmits the print setting set on the extension print setting screen illustrated in FIG. 5A to the cloud print driver 311 (s1013). The cloud print driver 311 displays the print setting screen illustrated in FIG. 4 again. The user operates the print setting screen 1300 to select the print button (s1014). The cloud print driver 311 generates print data based on the print setting set on the print setting screen 1300 and the print setting received from the print setting extension application 312 in s1013, and transmits the print data to the cloud print service 321 (s1015). In s1015, the cloud print driver 311 generates print data based on a print setting described in accordance with IPP and image data in a predetermined format such as PDF or PWG-Raster. Then, the cloud print driver 311 transmits the print data to the cloud print service 321. The cloud print service 321 stores the received print data in association with the designated print queue.

The cloud print compatible printer 104 transmits an obtainment request of the print data to the cloud print service 321 (s1016). The obtainment request may be transmitted by polling processing at predetermined interval, or may be transmitted by using a state where the user has logged in to the printer 104 as a trigger.

The cloud print service 321 transmits the print data stored in association with the print queue to the cloud print compatible printer 104 (s1017). The cloud print compatible printer 104 prints an image based on the received print data (s1018). Thereafter, the cloud print compatible printer 104 notifies the cloud print service 321 of print completion (s1019). It is noted that in FIG. 9, in s1007 and s1008, the print queue information is obtained, and the processing of determining the connection mode is performed. The determination on the connection mode may be performed based on the print queue information obtained in the processing of generating the print queue in the client terminal 101 (FIG. 16). In this case, s1007 to s1009 may be skipped.

The above-mentioned sequence is the sequence from the print setting up to the printing execution by the cloud print compatible printer 104.

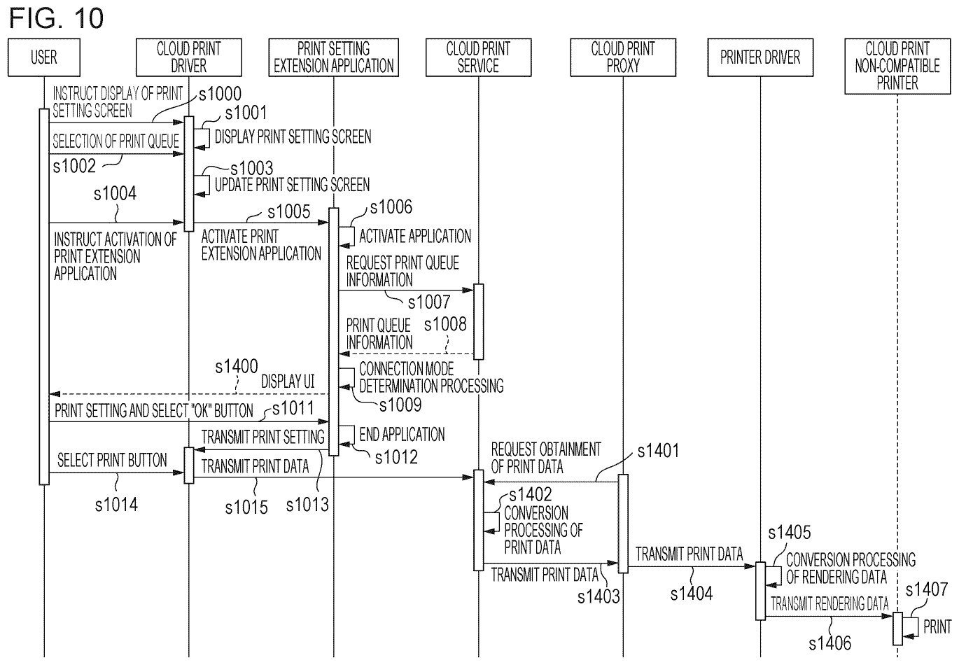

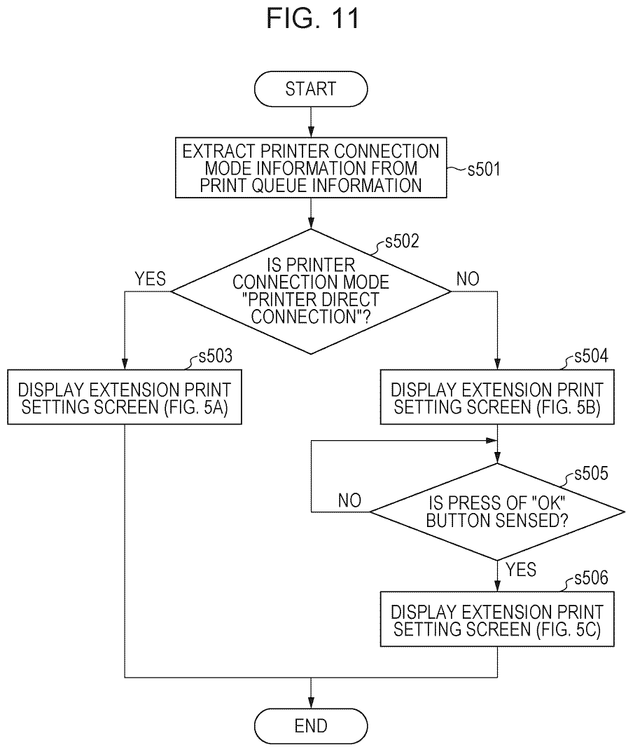

Next, with reference to FIG. 10, a sequence of printing using the cloud print non-compatible printer 105 will be described. It is noted that with regard to FIG. 10, a part where processing similar to that in FIG. 9 is performed is assigned with the same reference sign, and a description thereof will be omitted.

Since s1000 to s1009 are similar to those in FIG. 9, descriptions thereof will be omitted.

When information indicating connection via the cloud print proxy is added to the print queue information, the print setting extension application 312 displays a screen illustrated in FIG. 5B (s1400). FIG. 5B illustrates an example of the print setting UI of the print setting extension application 312. An extension print setting screen 811 displays an attention calling dialog 812 regarding a retrofitted finisher. Even when the equipment configuration information of the printer is changed with regard to the cloud print non-compatible printer 105 via the cloud print proxy server, the change may not be reflected on the print queue information of the cloud print service 321. In view of the above, the attention calling dialog 812 is displayed, and when the equipment configuration of the cloud print non-compatible printer 105 is changed, the user is prompted to register the printer again.

FIG. 5C illustrates the extension print setting screen 821 to be displayed after the dialog is closed in FIG. 5B. A punch setting and a secure print setting are not allowed to be performed on the extension print setting screen 821. The punch setting is not displayed since information of a finisher capable of punching is not registered in the equipment configuration information of the cloud print non-compatible printer 105. A password for secure print which is included in the print data generated by the cloud print driver 311 may not be converted into a format that can be used by the cloud print non-compatible printer. For this reason, in FIG. 5C, secure print is not displayed such that this setting is not allowed. In this manner, irrespective of the capability information and the configuration information of the printer, an extension print setting screen is displayed on which predetermined setting items, which are allowed to be set in FIG. 5A, are not allowed to be set in FIG. 5C. With the above-mentioned configuration, when printing using the cloud print non-compatible printer via the cloud print service 321 is to be performed, output under a setting that is not intended by the user is suppressed. Items that are allowed to be set in a case where the printer to be used is a cloud print compatible printer and that are not allowed to be set in a case where the printer to be used is a cloud print non-compatible printer include blank sheet saving, toner saving, binging without staple needles, a printing area setting, and the like. Blank sheet saving is a function of performing printing while blank pages in image data are skipped. Toner saving is a setting for saving the amount of toner to be used for printing. Binging without staple needles is a function of carrying out binging without using staples when output sheets are bound. The printing area setting is a function of setting an area to be printed in a sheet.

When conversion of the print data in the cloud print proxy server is to performed, the print setting extension application 312 displays an extension print setting screen with which a setting item that may not be converted by the cloud print proxy server is not allowed to be set. According to the present embodiment, with the above-mentioned configuration, when printing is executed via the cloud print proxy server, it is possible to suppress a situation where the print setting that is not allowed to be converted by the server is set.

FIG. 5D illustrates another example of the extension print setting screen displayed by the print setting extension application 312 when the print queue for printing via the cloud print proxy server is selected.

Herein, the extension print setting screen 831 is a screen to be displayed after the attention calling dialog with regard to the retrofitted finisher is closed. As described in a field 822, the secure print setting is allowed to be performed on the extension print setting screen 831. It is however noted that an attention calling message 823 is displayed indicating that no operation guarantee is offered when the secure print function is used.

The processing described in s1011 to s1015 is similar to that in FIG. 9.

The cloud print proxy 331 periodically transmits an obtainment request of the print data to the cloud print service 321 (s1401).

The cloud print service 321 refers to the print queue information to determine whether a transmission source of the obtainment request of the data is the cloud print compatible printer 104 or the cloud print proxy 331. When it is determined that the transmission source of the obtainment request of the print data is the cloud print proxy 331, the cloud print service 321 performs conversion processing of the print data (s1402). The cloud print service convers the print setting written in accordance with, for example, IPP into Print Ticket, and converts the image data in the PDF format into the XPS format.

Then, the cloud print service 321 transmits the print data obtained by the conversion in s1402 to the cloud print proxy 331 (s1403). It is noted that according to the present embodiment, in the cloud print service 321, the format of the print data is converted into a format that can be dealt with by the printer driver 332. The above-mentioned conversion may be performed by the cloud print proxy 331. In the above-mentioned case, the cloud print service 321 transmits the print data to the cloud print proxy 331 without performing the processing in s1402. The cloud print proxy 331 executes processing equivalent to s1402 on the received print data.

The cloud print proxy 331 transmits the received print data to the printer driver 332 (s1404).

The printer driver 332 executes conversion processing of converting the received print data into rendering data that can be processed by the cloud print non-compatible printer 105 (s1405). In s1405, the printer driver 332 generates Page Description Language (PDL) data based on the Print Ticket and the data in the XPS format which are received from the cloud print proxy 331.

The printer driver 332 transmits the generated rendering data to the cloud print non-compatible printer 105 (s1406).

The cloud print non-compatible printer 105 executes printing based on the received rendering data (s1407).

It is noted that in FIG. 9 and FIG. 10, in s1007, the obtainment request of the print queue information is transmitted to the cloud print service, and the determination on the connection mode is performed based on the print queue information obtained from the cloud print service. At timing in s1003, the cloud print driver may obtain the print queue information from the cloud print server and delivers the print queue information obtained in s1005 to a print extension application. In this case, the print setting extension application executes the connection mode determination processing based on the connection mode information of the print queue information obtained from the cloud print driver.

Next, an explanation on a detail of the connection determination processing described in s1009 in FIG. 9 and FIG. 10 will be provided with reference to FIG. 11. The processing described in FIG. 11 is realized when the CPU 212 of the client terminal 101 executes a program stored in the memory 213 or the storage unit 214.

A flow in FIG. 11 is started in response to a state where the print setting extension application 312 obtains the print queue information from the cloud print service 321.

First, when the print queue information is obtained, the print setting extension application 312 extracts, from the print queue information, information of the printer connection mode which has been set at the time of the printer registration (s501).

Next, the print setting extension application 312 determines whether or not the printer connection mode is “printer direct connection” (s502).

When the determination result is YES, the print setting extension application 312 displays the extension print setting screen 801 illustrated in FIG. 5A.

When the determination result is NO, the print setting extension application 312 displays the extension print setting screen 811 illustrated in FIG. 5B (s504). Then, the print setting extension application 312 determines whether or not the “OK” button in FIG. 5B is selected (s505). When the “OK” button is not selected, the print setting extension application 312 repeats the processing described in s505. When the “OK” button is selected, the print setting extension application 312 displays the extension print setting screen 831 illustrated in FIG. 5C (s506).

It is noted that in a case where the extension print setting screen illustrated in FIG. 5D is displayed when the “OK” button is selected in FIG. 5B, the print setting extension application 312 displays the screen illustrated in FIG. 5D instead of the screen illustrated in FIG. 5C in s506.

In this manner, in s502, processing of detecting information indicating that the selected print queue is a queue of the cloud print compatible printer that receives the print data from the cloud print service without intermediation of the cloud print proxy server is performed. When the information is detected in the processing, the screen illustrated in FIG. 5A is displayed on which a password for secure print is allowed to be set. On the other hand, the information is not detected in the above-mentioned processing, the screen illustrated in FIG. 5C is displayed on which a password for secure print is not allowed to be set. With the above-mentioned configuration, it is possible to suppress a situation where among the print settings that can be included in the print data generated by the cloud print driver, a setting item that may not be correctly converted when the print data is converted is set by the user.

As described above, since the print setting extension application 312 changes display contents on the UI according to the result of the determination on the connection mode between the cloud print service 321 and the printer, it is possible to suppress a situation where the setting item that may not be reflected on the output is set.

### Second Embodiment

According to the first embodiment, the example of the method has been described in which at the time of the printer registration, the cloud print service 321 determines the printer connection mode to add the connection mode information to the print queue information, and the print setting extension application 312 changes the UI by using the connection mode information.

According to the present embodiment, a method will be described in which when the print setting extension application 312 requests print queue information, the cloud print service 321 obtains ID information from the printer, and the print setting extension application 312 determines a connection status by using the ID information.

Here, only a difference from the first embodiment will be described.

According to the second embodiment, processing described in FIG. 8B is executed as a substitute for FIG. 8A of the first embodiment.

The processing described in FIG. 8B is realized when the program of the cloud print service 321 which is stored in the storage unit 224 of the cloud print server 102 is loaded onto the memory 223 to be executed by the CPU 222.

The device management unit 32102 receives a registration request of the printer (s411). The registration request of the printer includes the device information illustrated in FIG. 6G. According to the second embodiment, the device ID stores information for identifying the printer irrespective of whether the printer to be registered is the cloud print compatible printer 104 or the cloud print non-compatible printer 105.

The print queue management unit 32104 generates a print queue (s412). Then, the print queue management unit 32104 generates print queue information based on the received device information (s413). FIG. 6E illustrates the print queue information generated according to the second embodiment. The print queue information generated according to the second embodiment includes the ID information instead of the connection mode information illustrated in FIG. 6D. The ID information is empty at timing at which the print queue is generated.

The processing has been described above as a substitute for the processing in FIG. 8A of the first embodiment.

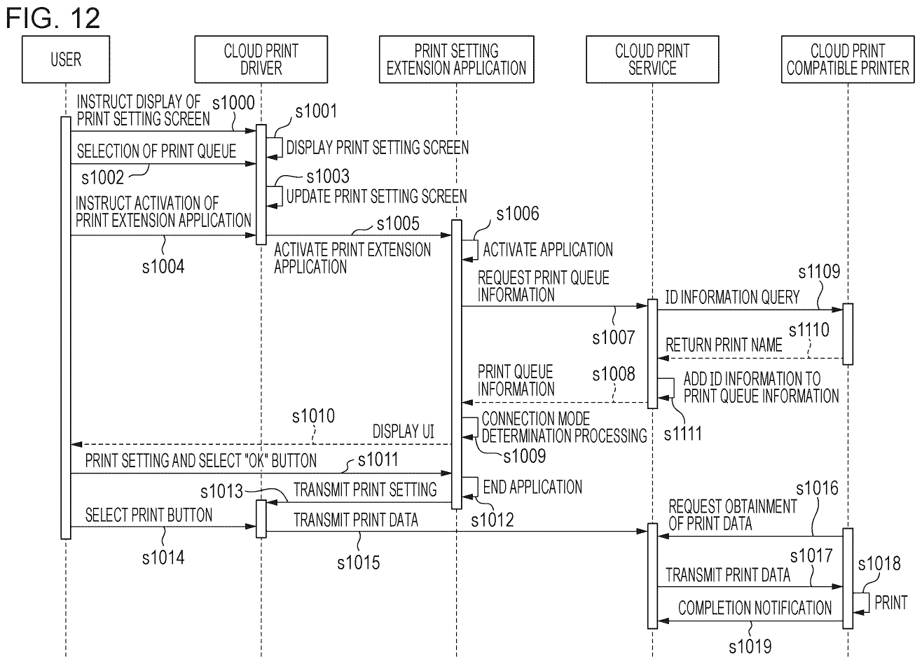

Subsequently, processing as a substitute for the processing in FIG. 9 of the first embodiment will be described with reference to FIG. 12. A part where processing similar to that in FIG. 9 is performed is assigned with the same reference sign, and a difference from that of the first embodiment will be described.

When the user selects the detail setting button on the print setting screen 1300, the print setting extension application 312 is activated (s1006). The print setting extension application 312 transmits an obtainment request of the print queue information to the cloud print service 321 (s1007). The cloud print service 321 transmits a query on the ID information to the cloud print compatible printer 104 (s1109). The cloud print compatible printer 104 receives the query on the ID information, and transmits the printer name to the cloud print service 321 (s1110).

The cloud print service 321 adds the received ID information to the print queue information (s1111). The subsequent processing is similar to that in FIG. 9.

It is noted that when the ID information has been already set in the print queue information, the processing described in s1109 to s1111 may be skipped.

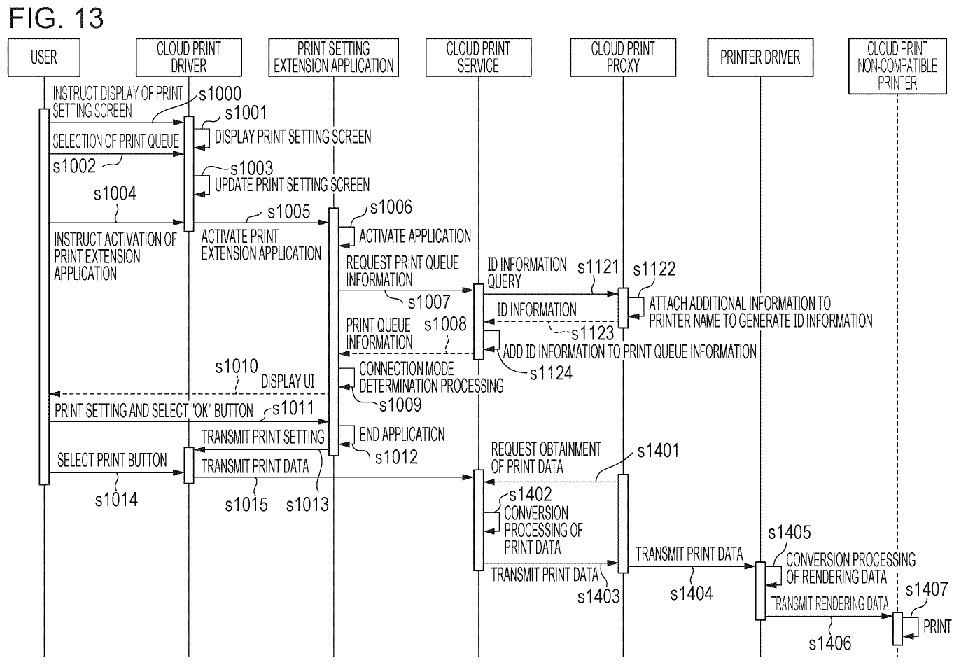

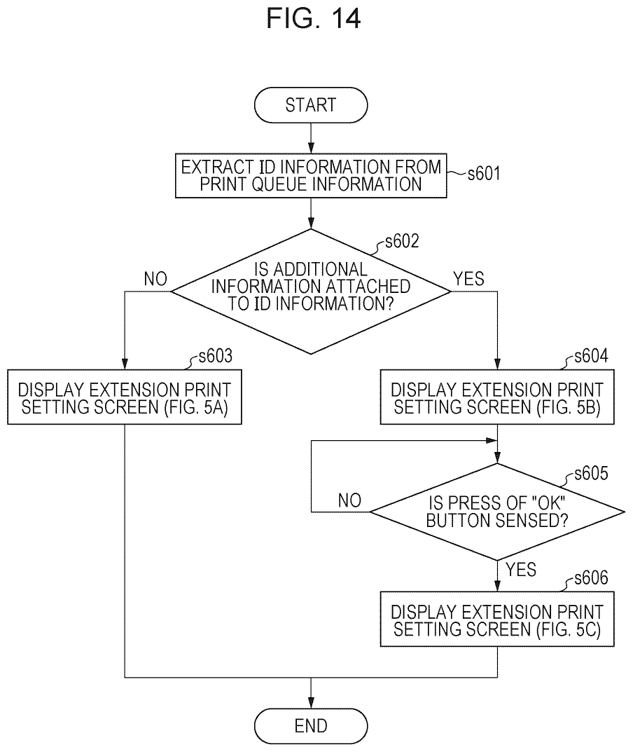

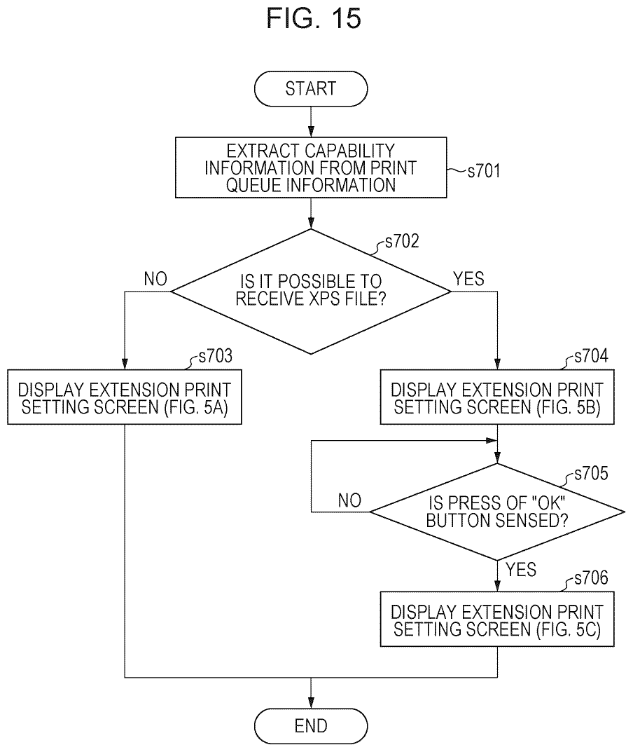

Next, processing as a substitute for the processing in FIG. 10 of the first embodiment will be described with reference to FIG. 13. A part where processing similar to that in FIG. 10 is performed is assigned with the same reference sign, and a difference from that of the first embodiment will be described.

When the user selects the detail setting button of the print setting screen 1300, the print setting extension application 312 is activated (s1006). The print setting extension application 312 transmits an obtainment request of the print queue information to the cloud print service 321 (s1007). The cloud print service 321 transmits a query on the ID information to the cloud print proxy 331 (s1121).

The cloud print proxy 331 attaches additional information to the printer name of the cloud print non-compatible printer 105 connected via the printer driver 332 to generate ID information (s1122). For example, when the printer name is a name “Printer-A”, additional information “Proxy” is attached to generate ID information “Printer-A-Proxy”.

The cloud print proxy 331 transmits the generated ID information to the cloud print service 321 (s1123).

The cloud print service 321 adds the received ID information to the print queue information (s1124).

It is noted that when the ID information has been already set in the print queue information, the processing described in s1121 to s1124 may be skipped.

In addition, the cloud print service issues a query on the ID information to the cloud print proxy or the cloud print compatible printer at the time of activation of the extension print application in the sequence illustrated in FIG. 12 and FIG. 13. At timing at which the print queue is generated in the cloud print service, a query on the ID information may be issued to the cloud print proxy or the cloud print compatible printer to set the obtained ID information in the print queue information. In the above-mentioned case, the ID information in the print queue information of the cloud print service is referred to at the time of activation of the print setting extension application, and the query on the ID information to the cloud print proxy or the cloud print compatible printer is not performed.

Processing equivalent to s1009 in FIG. 12 and s1009 in FIG. 13 will be described with reference to FIG. 14. Each block illustrated in a flowchart of FIG. 14 is realized when the program of the cloud print service 321 which is stored in the storage unit 224 of the cloud print server 102 is loaded onto the memory 223 to be executed by the CPU 222.

First, the connection mode determination unit 31203 of the print setting extension application 312 extracts ID information from the obtained print queue information (s601).

Then, the connection mode determination unit 31203 determines whether or not additional information is attached to the ID information (s602). The connection mode determination unit 31203 determines whether or not the additional information is attached based on whether or not a specific character string is included in the ID information. For example, when a character string “Proxy” is included in the ID information, it is determined that the additional information is attached. When the above-mentioned character string is not included, it is determined that the additional information is not attached. In addition, the printer name may be compared with the printer ID, and when a difference exists, it may be determined that the additional information is attached.

When it is determined that the additional information is not attached to the ID information, the extension application UI unit 31205 displays the extension print setting screen illustrated in FIG. 5A (s603).

When it is determined that the additional information is attached to the ID information, the extension application UI unit 31205 displays the screen illustrated in FIG. 5B (s604).

The extension application UI unit 31205 determines whether or not the “OK” button is selected (s605). Until the “OK” button is selected, the processing described in s605 is repeated.

When the “OK” button is selected, the extension application UI unit 31205 displays the extension print setting screen illustrated in FIG. 5C (s606). Thus, the processing related to the display of the extension print setting screen is ended.

As described above, the print setting extension application 312 determines the connection mode between the cloud print service 321 and the printer by using the ID information included in the print queue information obtained from the cloud print service 321. For this reason, even when the connection mode is not registered in the cloud print service 321, the extension print setting screen can be changed for the cloud print compatible printer and the cloud print non-compatible printer.

### Third Embodiment

According to the first embodiment, the method has been described in which at the time of the printer registration, the cloud print service 321 determines the printer connection mode and adds the connection mode information to the print queue information, and the print setting extension application 312 changes the UI by using the connection mode information.

According to the present embodiment, a method of determining a connection status by using the capability information included in the print queue information obtained by the print setting extension application 312 from the cloud print service 321.

Here, a difference from the first embodiment will be described.

According to the third embodiment, the processing described in FIG. 8B is executed as a substitute for FIG. 8A of the first embodiment. Since the processing in FIG. 8B according to the third embodiment is different from the processing according to the second embodiment, the processing will be described with reference to FIG. 8B.

The processing described in FIG. 8B is realized when the program of the cloud print service 321 which is stored in the storage unit 224 of the cloud print server 102 is loaded onto the memory 223 to be executed by the CPU 222.

The device management unit 32102 receives a registration request of the printer (s411). The registration request of the printer includes device information illustrated in FIG. 6G. According to the third embodiment, information for identifying the printer is stored in the device ID irrespective of whether the printer to be registered is the cloud print compatible printer 104 or the cloud print non-compatible printer 105. In addition, according to the third embodiment, a file format of image data that is supported by the printer is described as the capability information. For example, the cloud print compatible printer 104 notifies the cloud print service 321 of PDF and Raster as the supported file formats but does not notify the cloud print service 321 of XPS. On the other hand, the cloud print proxy 331 notifies the cloud print service 321 of XPS as the file format that is supported by the cloud print non-compatible printer 105.

The print queue management unit 32104 generates a print queue (s412). Then, the print queue management unit 32104 generates print queue information based on the received device information (s413). FIG. 6F illustrates the print queue information generated according to the third embodiment. The connection mode information illustrated in FIG. 6D is not included in the print queue information generated according to the third embodiment, but instead, a supported file format is included in the capability information.

According to the third embodiment, the sequence in FIG. 9 and FIG. 10 is similar to that of the first embodiment, but since a detail of the connection mode determination processing illustrated in s1009 is different, the sequence will be described with reference to FIG. 15.

FIG. 15 illustrates an example of the processing of the print setting extension application 312. The processing illustrated in FIG. 15 is realized when the program of the print setting extension application 312 which is stored in the storage unit 214 of the client terminal 101 is loaded onto the memory 213 to be executed by the CPU 212.

First, the connection mode determination unit 31203 of the print setting extension application 312 extracts capability information from the print queue information (s701).

The connection mode determination unit 31203 determines whether or not the XPS file is supported from the supported file format in the extracted capability information (s702).

When it is determined from the print queue information that the XPS file is not supported, the extension application UI unit 31205 of the print setting extension application 312 displays the extension print setting screen illustrated in FIG. 5A (s703).

On the other hand, when it is determined from the print queue information that the XPS file is supported, the extension application UI unit 31205 displays the screen illustrated in FIG. 5B (s704).

The extension application UI unit 31205 determines whether or not the “OK” button is selected (s705). Until the “OK” button is selected, the processing described in s705 is repeated.

When the “OK” button is selected, the extension application UI unit 31205 displays the extension print setting screen illustrated in FIG. 5C (s706). Thus, the processing related to the display of the extension print setting screen is ended.

As described above, the print setting extension application 312 can determine the connection mode between the cloud print service 321 and the printer by using the capability information included in the print queue information obtained from the cloud print service 321.

For this reason, even when the connection mode is not registered in the cloud print service 321, the extension print setting screen can be changed for the cloud print compatible printer and the cloud print non-compatible printer.

### Other Embodiments

According to the first embodiment to the third embodiment which have been described above, when the print queue of the cloud print non-compatible printer 105 is selected on the print setting screen 1300 and the detail setting button 1306 is selected, the screen illustrated in FIG. 5B is displayed. A configuration may also be adopted where without displaying the screen illustrated in FIG. 5B, the screen illustrated in FIG. 5C or FIG. 5D is displayed from the print setting screen 1300.

The embodiments of the present invention are also realized by executing the following processing. That is, software (program) configured to realize the functions of the above-mentioned embodiments is supplied to a system or apparatus via a network or various types of storage media, and a computer (or a CPU, an MPU, or the like) of the system or apparatus reads a program code to execute the processing. In this case, the computer program and the storage medium storing the computer program constitute the embodiments of the present invention.

The information processing apparatus according to the embodiments of the present invention can suppress a situation where the print setting under which the desired output may not be obtained by the printer at the output destination is set by the client terminal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus that is capable of communicating with a server system that provides a cloud print service, the information processing apparatus comprising:
one or more processors that execute a set of instructions, when executed, causing the information processing apparatus to perform operations comprising:
acquiring an application; and
on a first print setting screen that has been displayed by software different from the application, receiving selection of a printer from a user out of a plurality of printers including a) a compatible printer that is capable of communicating with the cloud print service and has been registered in the cloud print service based on a registration request transmitted from the compatible printer, and b) a non-compatible printer that is not capable of communicating with the cloud print service, but has been registered in the cloud print service based on a registration request transmitted from a server that is different from a server included in the server system to the cloud print service and has the non-compatible printer registered therein; and
in response to the selection of the printer on the first print setting screen, obtaining function information about the selected printer,
in response to selection of an object on the first print setting screen on which the compatible printer has been selected, generating, using the acquired application, a second print setting screen based on the obtained function information acquired from the cloud print service about the compatible printer and displaying the generated second print setting screen including a setting object to accept a setting of a value for a predetermined item related to printing which is not displayed on the first print setting screen, and
wherein, in response to selection of the non-compatible printer on the first print setting screen, function information about the non-compatible printer is obtained, and in response to selection of the object on the first print setting screen on which the non-compatible printer has been selected, a third print setting screen not including the setting object to accept the setting of the value for the predetermined item is displayed.

2. The information processing apparatus according to claim 1, wherein the one or more processors are configured to perform operations further comprising:
in a case that the compatible printer is selected and a print instruction is issued, transmitting image data, information of the compatible printer, and the value that is set via the setting object to the server system, and
in a case that the non-compatible printer is selected and a print instruction is issued, transmitting the image data and information of the non-compatible printer to the server system.

3. The information processing apparatus according to claim 1, wherein
the server system is configured to generate print data transmitted in accordance with IPP, and
the server that is different from the server included in the server system is configured to convert the print data transmitted in accordance with the IPP into a format that can be interpreted by a printer driver installed in the server that is different from the server included in the server system.

4. The information processing apparatus according to claim 1, wherein the one or more processors are configured to perform operations further comprising:
storing, in association with each other, information of the compatible printer and information indicating that the compatible printer is a printer configured to receive image data without intermediation of the server that is different from the server included in the server system,
wherein the one or more processors are configured to perform operations further comprising determining, based on the stored information, whether or not the compatible printer is a printer configured to receive print data via the server that is different from the server included in the server system.

5. The information processing apparatus according to claim 1, wherein the one or more processors are configured to perform operations further comprising displaying both information of the compatible printer and information of the non-compatible printer without displaying the setting object.

6. The information processing apparatus according to claim 1, wherein
the non-compatible printer is a printer that is not supporting print data transmitted by the server system, and
the server that is different from the server included in the server system is a server system configured to convert the print data transmitted by the server system into a format that is supported by the non-compatible printer.

7. The information processing apparatus according to claim 6, wherein the compatible printer is a printer that is supporting the print data transmitted by the server system.

8. The information processing apparatus according to claim 1, wherein the server that is different from the server included in the server system is a server system in which information of the non-compatible printer is registered.

9. The information processing apparatus according to claim 1, wherein the setting object is to accept a setting of a value for an item of a punch setting.

10. The information processing apparatus according to claim 1, wherein the setting object is to accept a setting of a value for an item of a binding setting without staple needles.

11. The information processing apparatus according to claim 1, wherein the application causes the information processing apparatus to obtain, from the cloud print service, the obtained function information about the compatible printer.

12. The information processing apparatus according to claim 1, wherein the printer driver causes the information processing apparatus to obtain, from the cloud print service, the obtained function information about the compatible printer.

13. A non-transitory computer-readable storage medium storing an application that, when executed by an information processing apparatus that (1) is capable of communicating with a server system that provides a cloud print service and (2) receives, on a first print setting screen that has been displayed by software different from the application, selection of a printer from a user out of a plurality of printers including a) a compatible printer that is capable of communicating with the cloud print service and has been registered in the cloud print service based on a registration request transmitted from the compatible printer, and b) a non-compatible printer that is not capable of communicating with the cloud print service, but has been registered in the cloud print service based on a registration request transmitted from a server that is different from a server included in a server system to the cloud print service and has the non-compatible printer registered therein, and (3) obtains, in response to selection of a printer on the first print setting screen, function information about the selected printer, causes the information processing apparatus to perform operations comprising:
in response to selection of an object on the first print setting screen that has been displayed by the software and on which the compatible printer has been selected, causing the information processing apparatus to generate a second print setting screen based on the obtained function information about the compatible printer and displaying the generated second print setting screen including a setting object to accept a setting of a value for a predetermined item related to printing which is not displayed on the first print setting screen,
wherein the application is acquired from an external apparatus and the acquired application is associated with a printer driver having been installed on the information processing apparatus, and
wherein in response to selection of the non-compatible printer on the first print setting screen, function information about the non-compatible printer is obtained, and in response to selection of the object on the first print setting screen on which the non-compatible printer has been selected, a third print setting screen not including the setting object to accept the setting of the value for the predetermined item is displayed.

14. The non-transitory computer-readable storage medium according to claim 13, wherein the application, when executed by the information processing apparatus, further causes the information processing apparatus to perform operations comprising:
in a case that the compatible printer is selected and a print instruction is issued, transmitting image data, information of the compatible printer, and the value that is set via the setting object to the server system, and
in a case that the non-compatible printer is selected and a print instruction is issued, transmitting the image data and information of the non-compatible printer to the server system.

15. The non-transitory computer-readable storage medium according to claim 13, wherein
the server system is configured to generate print data transmitted in accordance with IPP, and
the server that is different from the server included in the server system is configured to convert the print data transmitted in accordance with the IPP into a format that can be interpreted by a printer driver installed in the server that is different from the server included in the server system.

16. The non-transitory computer-readable storage medium according to claim 13,
wherein the information processing apparatus is further configured to store, in association with each other, information of the compatible printer and information indicating that the compatible printer is a printer configured to receive image data without intermediation of the server that is different from the server included in the server system,
wherein the application, when executed by the information processing apparatus, further causes the information processing apparatus to perform operations comprising determining, based on the stored information, whether or not the compatible printer is a printer configured to receive print data via the server that is different from the server included in the server system.

17. The non-transitory computer-readable storage medium according to claim 13, wherein the application, when executed by the information processing apparatus, further causes the information processing apparatus to perform operations comprising displaying both information of the compatible printer and information of the non-compatible printer without displaying the setting object.

18. The non-transitory computer-readable storage medium according to claim 13, wherein
the non-compatible printer is a printer that is not supporting print data transmitted by the server system, and
the server that is different from the server included in the server system is a server system configured to convert the print data transmitted by the server system into a format that is supported by the non-compatible printer.

19. The non-transitory computer-readable storage medium according to claim 18, wherein the compatible printer is a printer that is supporting the print data transmitted by the server system.

20. The non-transitory computer-readable storage medium according to claim 13, wherein the server that is different from the server included in the server system is a server system in which information of the non-compatible printer is registered.

21. The non-transitory computer-readable storage medium according to claim 13, wherein the setting object is to accept a setting of a value for an item of a punch setting.

22. The non-transitory computer-readable storage medium according to claim 13, wherein the setting object is to accept a setting of a value for an item of a binding setting without staple needles.

23. The non-transitory computer-readable storage medium according to claim 13, wherein the application causes the information processing apparatus to obtain, from the cloud print service, the obtained function information about the compatible printer.

24. The non-transitory computer-readable storage medium according to claim 13, wherein the printer driver causes the information processing apparatus to obtain, from the cloud print service, the obtained function information about the compatible printer.

25. A method comprising:
acquiring an application; and
on a first print setting screen that has been displayed by software different from the application, receiving selection of a printer from a user out of a plurality of printers including a) a compatible printer that is capable of communicating with a cloud print service provided by a server system and has been registered in the cloud print service based on a registration request transmitted from the compatible printer, and b) a non-compatible printer that is not capable of communicating with the cloud print service, but has been registered in the cloud print service based on a registration request transmitted from a server that is different from a server included in the server system to the cloud print service and has the non-compatible printer registered therein,
in response to the selection of the printer on the first print setting screen, obtaining function information about the selected printer,
in response to selection of an object on the first print setting screen on which the compatible printer has been selected, generating, using the acquired application, a second print setting screen based on the obtained function information acquired from the cloud print service about the compatible printer and displaying the generated second print setting screen including a setting object to accept a setting of a value for a predetermined item related to printing which is not displayed on the first print setting screen, and
wherein, in response to selection of the non-compatible printer on the first print setting screen, function information about the non-compatible printer is obtained, and in response to selection of the object on the first print setting screen on which the non-compatible printer has been selected, a third print setting screen not including the setting object to accept the setting of the value for the predetermined item is displayed.

26. The method according to claim 25, further comprising:
in a case that the compatible printer is selected and a print instruction is issued, transmitting image data, information of the compatible printer, and the value that is set via the setting object to the server system, and
in a case that the non-compatible printer is selected and a print instruction is issued, transmitting the image data and information of the non-compatible printer to the server system.

27. The method according to claim 25, wherein
the server system is configured to generate print data transmitted in accordance with IPP, and
the server that is different from the server included in the server system is configured to convert the print data transmitted in accordance with the IPP into a format that can be interpreted by a printer driver installed in the server that is different from the server included in the server system.

28. The method according to claim 25, further comprising:
storing, in association with each other, information of the compatible printer and information indicating that the compatible printer is a printer configured to receive image data without intermediation of the server that is different from the server included in the server system,
wherein the one or more processors are configured to perform operations further comprising determining, based on the stored information, whether or not the compatible printer is a printer configured to receive print data via the server that is different from the server included in the server system.

29. The method according to claim 25, further comprising displaying both information of the compatible printer and information of the non-compatible printer without displaying the setting object.

30. The method according to claim 25, wherein
the non-compatible printer is a printer that is not supporting print data transmitted by the server system, and
the server that is different from the server included in the server system is a server system configured to convert the print data transmitted by the server system into a format that is supported by the non-compatible printer.

31. The method according to claim 30, wherein the compatible printer is a printer that is supporting the print data transmitted by the server system.

32. The method according to claim 25, wherein the server that is different from the server included in the server system is a server system in which information of the non-compatible printer is registered.

33. The method according to claim 25, wherein the setting object is to accept a setting of a value for an item of a punch setting.

34. The method according to claim 25, wherein the setting object is to accept a setting of a value for an item of a binding setting without staple needles.

35. The method according to claim 25, wherein the application causes the information processing apparatus to obtain, from the cloud print service, the obtained function information about the compatible printer.

36. The method according to claim 25, wherein the printer driver causes the information processing apparatus to obtain, from the cloud print service, the obtained function information about the compatible printer.
